(19) United States
(12) Patent Application Publication
(10) Pub. No.: US 2026/0116382 A1
(43) Pub. Date: Apr. 30, 2026

(54) METHOD AND APPARATUS FOR GENERATING REAR-SIDE LANE FOR VEHICLE

(71) Applicants: Hyundai Motor Company, Seoul (KR); Kia Corporation, Seoul (KR)

(72) Inventor: Sung Wook LEE, Hwaseong-Si (KR)

(21) Appl. No.: 19/230,713

(22) Filed: Jun. 6, 2025

(30) Foreign Application Priority Data
Oct. 30, 2024 (KR) 10-2024-0150767

(51) Int. Cl. B60W 30/12; B60W 30/09; B60W 30/095; B60W 50/00; G06V 20/56

(52) U.S. Cl. CPC B60W 30/12; B60W 30/09; B60W 30/0956; B60W 50/0097; G06V 20/588; B60W 2420/403; B60W 2520/105; B60W 2520/14; B60W 2540/18; B60W 2552/30; B60W 2552/53; B60W 2556/10

(57) ABSTRACT

A method performed by an apparatus of a vehicle may comprise obtaining coordinate values of a plurality of points on a lane ahead of the vehicle at predetermined time intervals using at least one sensor of the vehicle, wherein the coordinate values are defined in a cartesian coordinate system having the vehicle at an origin, a first axis parallel to a direction of travel of the vehicle, and a second axis perpendicular to the direction of travel, generating a signal indicating a lane curve representing a rearward portion of the lane based on coordinate values of a plurality of rear-side points, wherein the plurality of rear-side points correspond to points from the plurality of points that are positioned to a rear side of the vehicle as the vehicle moves forward, and controlling, based on the signal, driving of the vehicle.

### CROSS-REFERENCE TO RELATED APPLICATIONS

This application claims the benefit of priority to Korean Patent Application No. 10-2024-0150767, filed in the Korean Intellectual Property Office on Oct. 30, 2024 in the Korea Intellectual Property Office, the entire contents of which are incorporated herein by reference.

### TECHNICAL FIELD

The present disclosure in some examples relates to a method and apparatus for generating a rear-side lane of a vehicle. More particularly, the present disclosure relates to a method and apparatus for generating a rear-side lane based on forward lane detection information and position information of an ego vehicle.

### BACKGROUND

The matters described in this Background section are only for enhancement of understanding of the background of the disclosure, and should not be taken as acknowledgment that they correspond to prior art already known to those skilled in the art.

An autonomous vehicle may predict the future path of its surrounding objects (target) for route planning, collision avoidance determination, etc. For example, if there exist objects such as other vehicles, pedestrians, personal mobility devices, etc. in the vicinity of the autonomous vehicle, the autonomous vehicle may predict the future path of the objects (target) to warn the driver or perform an evasive maneuver before a collision occurs.

Lane (lane lines) information is material for predicting the path of the target and determining the relative driving path and lateral distance between the ego vehicle and the target. A target vehicle that is traveling at a high speed while maintaining a certain distance within a lane is likely to continue traveling along the lane in the future. Therefore, predicting the future path of the target along the lane may improve path prediction accuracy in such situations.

Lane detection techniques may require lane images obtained from cameras. To generate reliable lane information during driving, it is desirable to have a camera sensor that may capture lane images.

Autonomous vehicles may only detect lanes in front of them because the camera for obtaining lane information may be disposed only forwardly of the vehicles. The autonomous vehicles may not obtain rear-side lane information while driving, so they may not be able to perform path prediction and collision avoidance determination based on lane information for targets located rearwardly thereof.

### SUMMARY

The present disclosure is directed at providing a method and device that may generate a rear-side lane even without a sensor or camera capable of detecting a physical rear-side lane.

The present disclosure aims to provide a method and device that may minimize lane information errors caused by vehicle jolting or sensor measurement errors, thereby improving the accuracy of rear-side lane generation.

Technical objects to be achieved by the present disclosure are not limited to those described above, and other technical objects not mentioned above may also be clearly understood from the detailed descriptions given below by those skilled in the art to which the present disclosure belongs.

According to the present disclosure, a method performed by an apparatus of a vehicle, the method may comprise obtaining coordinate values of a plurality of points on a lane ahead of the vehicle at predetermined time intervals using at least one sensor of the vehicle, wherein the coordinate values are defined in a cartesian coordinate system having the vehicle at an origin, a first axis parallel to a direction of travel of the vehicle, and a second axis perpendicular to the direction of travel, generating a signal indicating a lane curve representing a rearward portion of the lane based on coordinate values of a plurality of rear-side points, wherein the plurality of rear-side points correspond to points from the plurality of points that are positioned to a rear side of the vehicle as the vehicle moves forward, and controlling, based on the signal, driving of the vehicle.

The method, wherein the lane curve is represented by a polynomial, and wherein the lane curve is determined based on a difference between point values of the polynomial and the coordinate values of the plurality of rear-side points being minimized.

The method, wherein the lane curve is a cubic polynomial.

The method, wherein the generating of the signal may comprise determining an average of candidate coordinate values of each rear-side point, and generating the lane curve based on the averages of the candidate coordinate values of the plurality of rear-side points.

The method, wherein the generating of the signal may comprise determining an average of candidate coordinate values of each rear-side point and a variance of the candidate coordinate values of each rear-side point, and generating a lane curve based on a difference between point values associated with the lane curve and the averages of the candidate coordinate values of the plurality of rear-side points being minimized, and wherein the lane curve is further based on weights proportional to an inverse of each of the variances.

The method, wherein the obtaining of the coordinate values of the plurality of points on the lane ahead of the vehicle may comprise excluding, based on a lane detection reliability of the at least one sensor, invalid coordinate values from the coordinate values of the plurality of points.

The method, wherein the obtaining of the coordinate values of the plurality of points on the lane ahead of the vehicle may comprise excluding, based on a curvature of the lane ahead of the vehicle, invalid coordinate values from the coordinate values of the plurality of points.

The method, wherein the obtaining of the coordinate values of the plurality of points on the lane ahead of the vehicle may comprise excluding, based on a lateral offset of the lane ahead of the vehicle, invalid coordinate values from the coordinate values of the plurality of points.

The method, wherein the obtaining of the coordinate values of the plurality of points on the lane ahead of the vehicle may comprise excluding, based on a velocity of the vehicle, invalid coordinate values from the coordinate values of the plurality of points.

The method, wherein the obtaining of the coordinate values of the plurality of points on the lane ahead of the vehicle may comprise excluding, based on a heading angle of the vehicle, invalid coordinate values from the coordinate values of the plurality of points.

The method, wherein the obtaining of the coordinate values of the plurality of points on the lane ahead of the vehicle may comprise excluding, based on a yaw rate of the vehicle, invalid coordinate values from the coordinate values of the plurality of points.

According to the present disclosure, an apparatus of a vehicle, the apparatus may comprise a processor, and a memory storing at least one instruction that, when executed by the processor communicating with the memory, is configured to cause the apparatus to obtain coordinate values of a plurality of points on the lane ahead of the vehicle at predetermined time intervals using at least one sensor of the vehicle, wherein the coordinate values are defined in a cartesian coordinate system having the vehicle at an origin, a first axis parallel to a direction of travel of the vehicle, and a second axis perpendicular to the direction of travel, generate a signal indicating a lane curve representing a rearward portion of the lane based on coordinate values of a plurality of rear-side points, wherein the plurality of rear-side points correspond to points from the plurality of points that are positioned to a rear side of the vehicle as the vehicle moves forward, and control, based on the signal, driving of the vehicle.

According to the present disclosure, a method performed by an apparatus of a vehicle, the method may comprise obtaining forward lane detection information from at least one sensor of the vehicle at predetermined intervals, wherein the forward lane detection information may comprise coordinate values for a plurality of points on a lane ahead of the vehicle, estimating, based on driving information obtained from the vehicle, a current position of the vehicle at each of the predetermined intervals, updating, based on the estimated current position of the vehicle at each of the predetermined intervals, coordinate values of previously obtained points on the lane such that the updated coordinate values correspond to points positioned rearward of the vehicle as the vehicle moves forward, outputting, based on the updated coordinate values of the points positioned rearward of the vehicle, a signal indicating a rearward portion of the lane, and controlling, based on the signal indicating the rearward portion of the lane, driving of the vehicle.

The method, wherein the estimating of the current position of the vehicle at each of the predetermined intervals may comprise determining a current vehicle position using dead reckoning based on the driving information, wherein the driving information may comprise at least one of a velocity of the vehicle, an acceleration of the vehicle, a steering angle of the vehicle, a steering angle velocity of the vehicle, a heading angle of the vehicle, or a yaw rate of the vehicle.

The method, wherein the updating of the coordinate values may comprise updating the coordinate values of previously obtained points on the lane from earlier time points into a coordinate system defined at the estimated current position of the vehicle and heading of the vehicle.

The method, wherein the outputting of the signal may comprise determining, based on the updated coordinate values corresponding to the points positioned rearward of the vehicle, a polynomial lane curve using a least squares fitting method.

The method, wherein the outputting of the signal may comprise based on an average of the updated coordinate values corresponding to the points positioned rearward of the vehicle and a variance of the updated coordinate values corresponding to the points positioned rearward of the vehicle, determining a polynomial lane curve using a weighted least squares fitting method, wherein the polynomial lane curve is determined such that differences between the polynomial lane curve and the updated coordinate values are weighted based on an inverse of the variance.

The method, wherein the at least one sensor may comprise a forward-facing camera, and wherein the forward lane detection information may comprise at least one of a lane lateral offset between the lane and the vehicle, a lane heading angle, a lane curvature of the lane ahead of the vehicle, or a lane curvature rate of the lane curvature.

The method, wherein the controlling of the driving of the vehicle may comprise providing the signal to a blind-spot collision warning or assist (BCW/A) system of the vehicle, wherein the BCW/A system is configured to predict, based on the signal indicating the rearward portion of the lane, a future path of a target vehicle positioned rearwardly of the vehicle.

The method may further comprise selectively storing the coordinate values based on at least one of, a reliability of a sensor exceeding a reference value, a curvature of the lane ahead of the vehicle being below a reference value, a lateral offset between the vehicle and the lane ahead of the vehicle being within a reference range, a velocity of the vehicle being within a reference range, a steering angle of the vehicle exceeding a reference value, or a yaw rate of the vehicle exceeding a reference value.

The advantageous effects of the present disclosure are not limited to those described above; other advantageous effects of the present disclosure not mentioned above may be understood clearly by those skilled in the art from the descriptions given below.

### BRIEF DESCRIPTION OF THE DRAWINGS

FIG. 1 shows an example of a lane generating device according to at least one example of the present disclosure.

FIG. 2 shows an example of a plurality of points on a lane, which are collected by the lane generating device according to at least one example of the present disclosure.

FIG. 3A, FIG. 3B, FIG. 3C, and FIG. 3D show an example of a method performed by the lane generating device for collecting coordinates of a first point on a lane, according to at least one example of the present disclosure.

FIG. 4A, FIG. 4B, FIG. 4C, and FIG. 4D show an example of a method performed by the lane generating device for generating a rear-side lane by using the rear-side lane coordinates, according to at least one example of the present disclosure.

FIG. 5 shows an example of a method performed by the lane generating device for generating a rear-side lane, according to at least one example of the present disclosure.

FIG. 6 shows an example of a process performed by the lane generating device for determining whether to collect lane coordinates, according to another example of the present disclosure.

FIGS. 7A and 7B show an example of a lane generating device according to the present disclosure improves the performance of a blind-spot collision warning/assist system.

FIG. 8 shows an example of a configuration of a computing device that may be used to implement the methods or devices according to the present disclosure.

### DETAILED DESCRIPTION

Hereinafter, some examples of the present disclosure will be described in detail with reference to the accompanying drawings. In the following description, like reference numerals preferably designate like elements, although the elements are shown in different drawings. Further, in the following description of some examples, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of generating a rea-side lane of a vehicle based on past forward detections) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of generating a rea-side lane of a vehicle based on past forward detections) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of generating a rea-side lane of a vehicle based on past forward detections) described herein.

Minimum risk maneuver (MRM) operation(s) may also be controlled, for example, based on one or more features (e.g., features of generating a rea-side lane of a vehicle based on past forward detections) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of generating a rea-side lane of a vehicle based on past forward detections) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of generating a rea-side lane of a vehicle based on past forward detections) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

An autonomous driving level and/or autonomous driving activation/deactivation may also be controlled, for example, based on one or more features (e.g., features of generating a rea-side lane of a vehicle based on past forward detections) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

The following detailed description, together with the accompanying drawings, is intended to describe examples of the present disclosure, and is not intended to represent the only examples in which the present disclosure may be practiced.

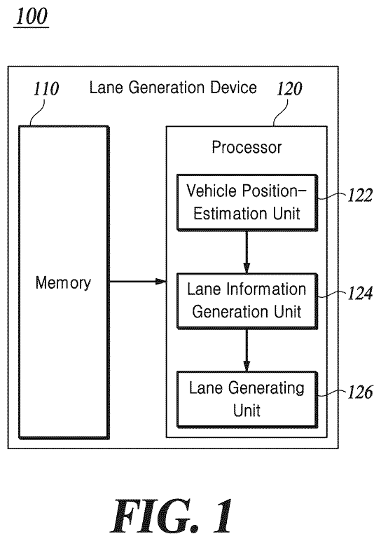

FIG. 1 shows an example of a lane generating device 100 according to at least one example of the present disclosure.

The lane generating device 100 includes a memory 110 and a processor 120. The lane generating device 100 may be implemented in the form of an embedded device, a server, a microcontroller, an FPGA, electronics within an autonomous driving system, or the like (e.g., an ECU, an ADAS controller, a domain control unit, or a sensor fusion module, etc.). Not all of the blocks shown in FIG. 1 are requisite components, and in other examples, some blocks included in the lane generating device 100 may be added, changed, or deleted. Further, the components shown in FIG. 1 represent functionally distinct elements, and at least one of the components may be implemented in a form that integrates with other functional modules in an actual physical environment.

The memory 110 stores data and commands or instructions required for the operation of the lane generating device 100.

The memory 110 may store the driving information of a vehicle, which is obtained by using at least one sensor included in the vehicle. The vehicle driving information may include a vehicle speed, velocity, an acceleration, a steering angle, a steering angle velocity, a heading angle, and/or a yaw rate (e.g., from an IMU, a wheel speed sensor, a steering torque sensor, or a GPS module, etc.).

The memory 110 may store forward lane detection information obtained by using at least one forward sensor (e.g., a forward-facing camera) included in the vehicle. The forward lane detection information may include a lane lateral offset between the vehicle and the lane, a lane heading angle, a lane curvature, and/or a lane curvature rate (e.g., from a monocular camera, a stereo camera, or a LiDAR system, etc.).

The processor 120 controls operations throughout the lane generating device 100. The processor 120 may be implemented as one or more processors. The processor 120 may execute instructions stored in the memory 110 to perform lane generation and vehicle position estimation tasks in real time.

The processor 120 may include a vehicle position-estimation unit 122, a lane information-generating unit 124, and a lane generating unit 126 (e.g., implemented as software modules, firmware routines, or dedicated hardware circuits, etc.).

The vehicle position-estimation unit 122 may calculate the current position information of the vehicle by using the vehicle's current driving information stored in the memory 110. The vehicle position information may include a position (x, y) of the vehicle and a heading angle (φ) of the vehicle.

In at least one example of the present disclosure, the vehicle position-estimation unit 122 may use dead reckoning to calculate the vehicle's current position information from the vehicle position information at a previous point in time. For example, Equation 1 shows how to calculate the vehicle position at a current time from the vehicle position information at a previous time by using the velocity and acceleration information of the vehicle (e.g., from a wheel speed sensor, an inertial measurement unit (IMU), or a GNSS module, etc.).

$${X}_{t} = {X}_{t - 1} + ( V + \frac{1}{2} A \cdot Δ t ) Δ t \cdot cos ( {φ}_{t - 1} ) \qquad [ Equation 1 ]$$

$${Y}_{t} = {Y}_{t - 1} + ( V + \frac{1}{2} A \cdot Δ t ) Δ t \cdot sin ( {φ}_{t - 1} )$$

Equation 1, (Xₜ₋₁, Yₜ₋₁, φₜ₋₁) represents the vehicle position information at a previous time point, where V is the magnitude of the current velocity of the vehicle, A the magnitude of the current acceleration of the vehicle, Δt the time interval between the previous time point and the current time point, and (Xₜ, Yₜ) represent the current position of the vehicle.

Equation 2 shows how to calculate the vehicle heading angle at the current time from the vehicle position information at the previous time, by using the driving curvature, velocity, and acceleration information of the vehicle.

$${ρ}_{t - 1} = {w}_{1} \frac{tan ( θ )}{L} + {w}_{2} \frac{{γ}_{t - 1}}{V} \qquad [ Equation 2 ]$$

$${φ}_{t} = {φ}_{t - 1} + {ρ}_{t - 1} \cdot V \cdot Δt$$

In Equation 2, ρₜ₋₁ represents the driving curvature of the vehicle at the previous time point, where θ is the steering angle of the vehicle, L is the length of the vehicle, and γₜ₋₁ is the yaw rate of the vehicle at the previous time point. w₁ and w₂ are weights, satisfying w₁+w₂=1. In Equation 2, φₜ₋₁ is the heading angle of the vehicle at the previous time point and φₜ is the heading angle of the vehicle at the current time point.

The lane information-generating unit 124 collects one or more coordinates for each of multiple points constituting the lane, by using the forward lane detection information stored in the memory 110 (e.g., detected by a monocular camera, stereo camera, LiDAR, or fused vision system, etc.).

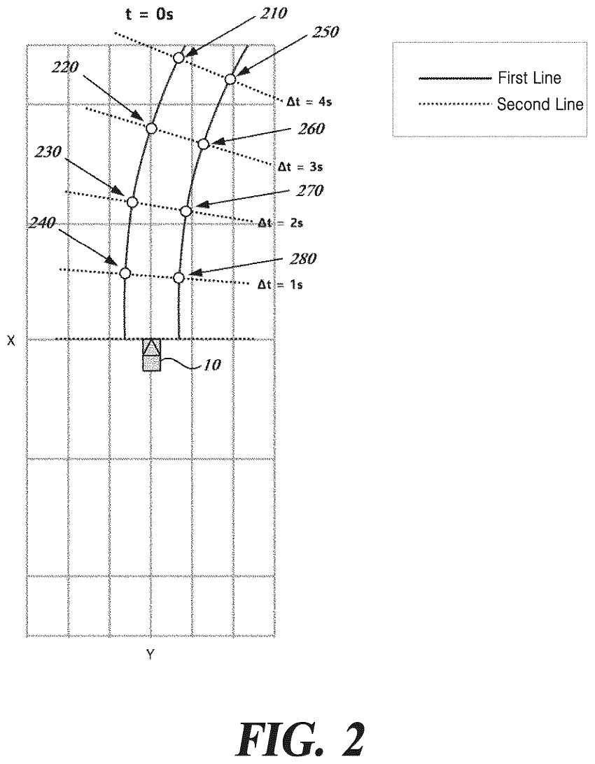

FIG. 2 shows an example of a plurality of points on a lane, which are collected by the lane generating device 100 according to at least one example of the present disclosure. In FIG. 2, the first lines represent the lanes ahead of a vehicle 10 that is traveling, and the second lines represent the positions that the vehicle 10 is predicted to reach in Δt seconds from the current time (e.g., based on estimated velocity, heading angle, or curvature, etc.). The example of FIG. 2 assumes that the vehicle 10 is aware of the lanes ahead of it for 4 seconds, and that it obtains lane detection information every 1 second (e.g., based on a fixed time-triggered update interval or sensor sampling rate, etc.).

The lane generating device 100 collects coordinates of the first point 210 through the eighth point 280 based on the current-time (t=0 s) forward lane detection information obtained by using the forward sensor. The respective points in the forward lane may be represented by coordinate values (x, y) in a vehicle coordinate system in which the vehicle is located at the origin (e.g., where the x-axis extends along the forward direction of travel and the y-axis extends laterally). The lane generating device 100 collects the coordinate values representing each point in the forward lane and stores them in the memory 110.

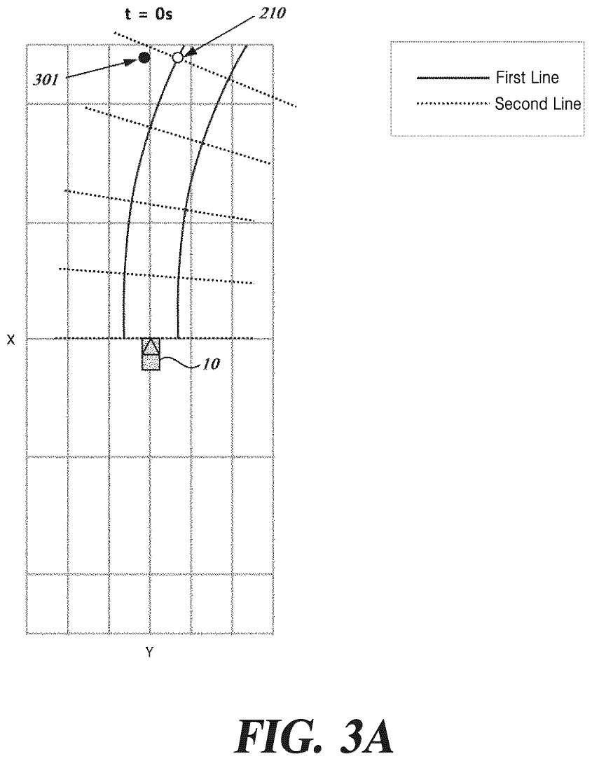

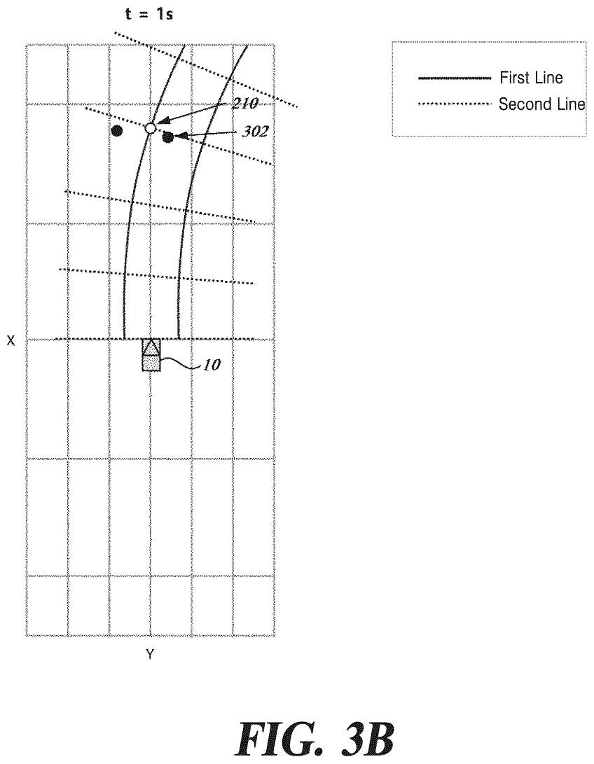

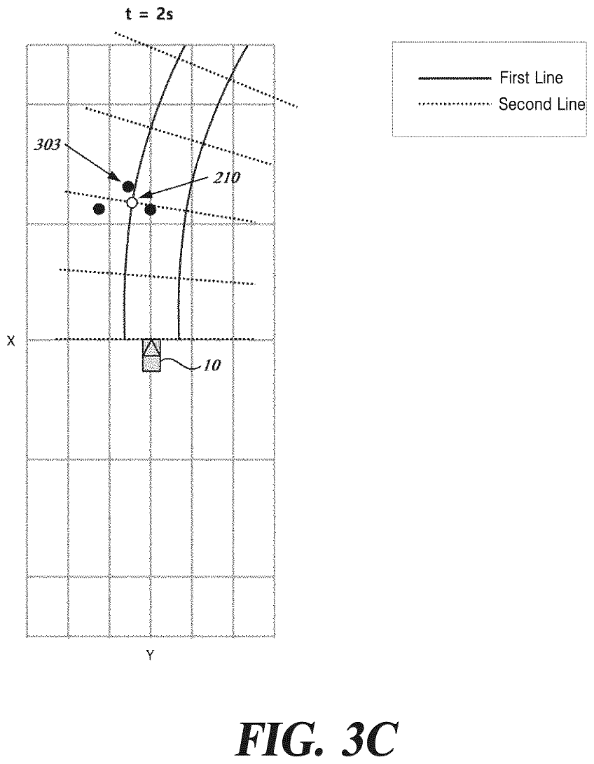

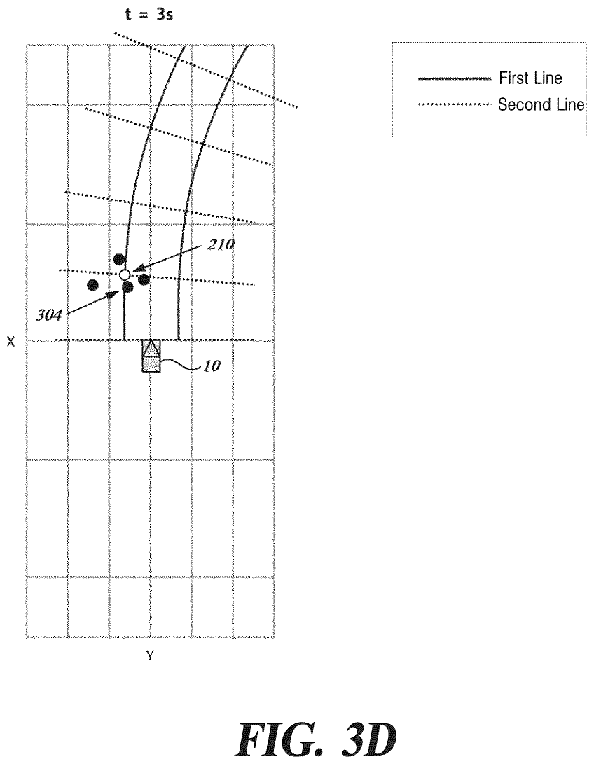

FIGS. 3A through 3D show an example of a method performed by the lane generating device 100 for collecting coordinates of the first point 210 on the lane, for example, based on successive forward lane detection and vehicle position estimation, according to at least one example of the present disclosure. In FIGS. 3A to 3D, the first lines represent lanes ahead of the traveling vehicle 10, and the second lines represent positions that the vehicle 10 is predicted to reach Δt seconds from the current time point. As in the example of FIG. 2, it is assumed that the vehicle 10 is aware of the forward lanes for 4 seconds and acquires lane detection information every 1 second (e.g., from continuous sensor measurements with discrete storage intervals, etc.).

FIG. 3A shows first coordinate values 301 of the first point 210, which are obtained at a current time point (t=0 s). The lane information-generating unit 124 obtains the first coordinate values 301 of the first point 210 based on the forward lane detection information at the current time, which is obtained by using the forward sensor. The lane information-generating unit 124 stores the first coordinate values 301 in the memory 110 to collect the coordinate values of the first point 210 for use in lane trajectory modeling or later statistical processing.

FIG. 3B shows a method of re-collecting coordinate values of the first point 210 after a time interval of one second. The lane information-generating unit 124 utilizes the current position information of the vehicle 10, which is obtained from the vehicle position-estimation unit 122, and the previous position information (e.g., from dead reckoning or inertial integration), to update the coordinate values 301 of the first point 210 to conform to the vehicle coordinate system at the current time (t=1 s). The lane information-generating unit 124 obtains second coordinate values 302 of the first point 210 based on the current-time forward lane detection information obtained by using the forward sensor. The lane information-generating unit 124 stores the second coordinate value 302 in the memory 110 to collect the coordinate values of the first point 210, for example, in a time-series fashion.

FIG. 3C shows a process of re-collecting coordinate values of the first point 210 after another one-second period. The lane information-generating unit 124 utilizes the current position information of the vehicle 10, which is obtained from the vehicle position-estimation unit 122, and the previous position information (e.g., obtained from prior estimations or sensor fusion data, etc.) to update the coordinate values 301 and 302 of the first point 210 to conform to the vehicle coordinate system at the current time (t=2 s). The lane information-generating unit 124 obtains third coordinate values 303 of the first point 210 based on the current-time forward lane detection information obtained by using the forward sensor. The lane information-generating unit 124 stores the third coordinate value 303 in the memory 110 to collect coordinate values of the first point 210, for example, as part of a rolling coordinate history.

FIG. 3D shows the continued process of re-collecting coordinate values of the first point 210 after yet another one-second period. The lane information-generating unit 124 utilizes the current position information of the vehicle 10, which is obtained from the vehicle position-estimation unit 122, and the previous position information (e.g., from prior timestamps or accumulated dead reckoning data, etc.) to update the coordinate values 301 to 303 of the first point 210 to conform to the vehicle coordinate system at the current time (t=3 s). The lane information-generating unit 124 obtains fourth coordinate values 304 of the first point 210 based on the current-time forward lane detection information obtained by using the forward sensor (e.g., a camera or LiDAR system, etc.). The lane information-generating unit 124 stores the fourth coordinate value 304 in the memory 110 to collect coordinate values of the first point 210, for example, over multiple successive time points.

The lane generating unit 126 generates a rear-side lane by using lane coordinates located rearwardly of the vehicle 10. The rear-side lane generated by the lane generating unit 126 may be represented by a polynomial of degree N that is a natural number, and in particular may be represented by a cubic polynomial (e.g., to fit the accumulated rearward lane coordinates using least squares or weighted least squares methods, etc.).

The lane generating unit 126 may calculate the probability information of the lane coordinates collected for each point on the road and generate the rear-side lance based on the probability information (e.g., derived from statistical analysis of time-series coordinate data, etc.). In the present disclosure, the probability information represents a distribution of coordinates collected for a particular point on the roadway, such as the mean and/or variance of the coordinate values (e.g., computed from repeated coordinate samples over successive time intervals). The lane generating unit 126 may use the probability information of the collected coordinates to generate a rear-side lane, thereby minimizing a lane generation error. The lane generation error is mainly caused by the jolting of the vehicle 10, sensor draft, lane detection uncertainty, or the detection error of the sensor.

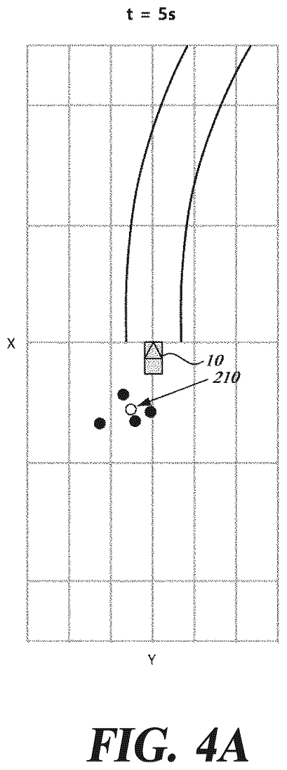

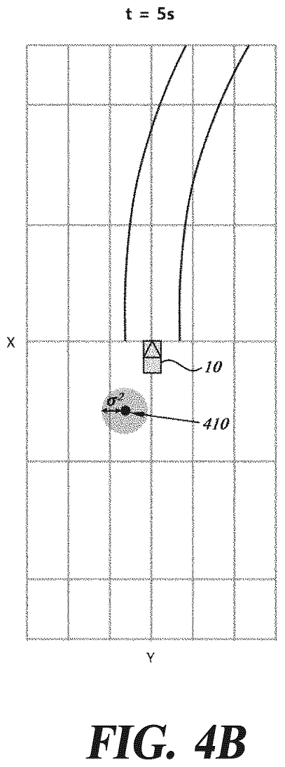

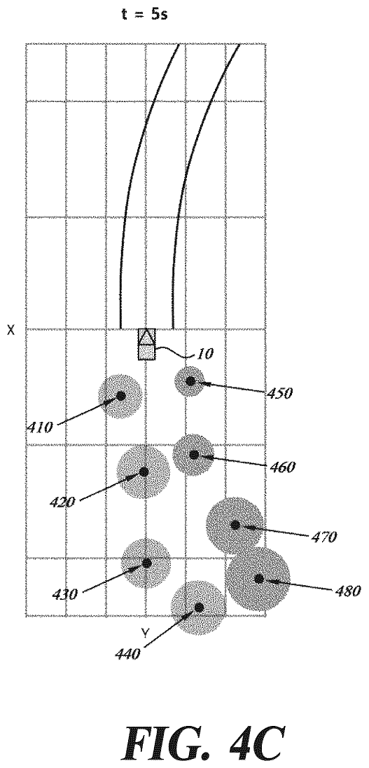

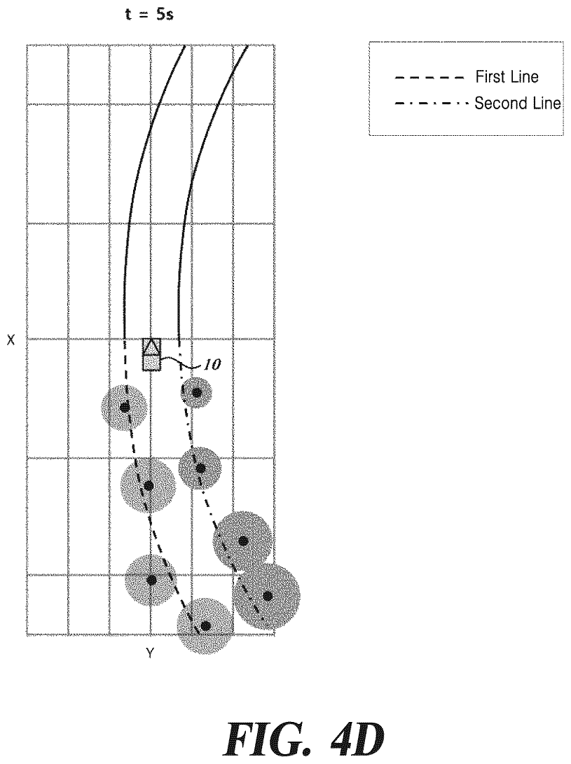

FIGS. 4A through 4D show an example of a method performed by the lane generating device 100 for generating a rear-side lane by using the rear-side lane coordinates, according to at least one example of the present disclosure.

FIG. 4A shows, at a current time point (t=5 s), the first point 210 and its lane coordinates 301 to 304 collected in FIGS. 3A through 3D. At the current time point (t=5 s), the first point 210 and its lane coordinates 301 to 304 are located rearwardly of the vehicle 10 (e.g., having passed the origin point in the vehicle coordinate system).

The lane generating unit 126 calculates a mean and/or variance of the collected rear-side lane coordinates 301 to 304 (e.g., by computing the arithmetic average and standard deviation across the x and y components of the coordinate values). FIG. 4B shows a mean 410 and a variance σ² of the lane coordinate values 301 to 304 of the first point.

As with the first point, the lane generating unit 126 calculates probability information of coordinates for each of the points located rearwardly of the vehicle 10 (e.g., across multiple spatially distributed lane points over time). FIG. 4C shows mean (410 to 480) and variance of the lane coordinate values for each of the first point 210 through the eighth point 280.

The lane generating unit 126 generates a rear-side lane by using the probability information of the rear-side lane coordinates, for example, to fit a smooth curve that approximates the actual lane shape. FIG. 4D shows a rear-side lane generated by the lane generating unit 126 using the probability information of the respective points. In FIG. 4D, the first line represents a left rear-side lane generated based on the mean (410 to 440) and/or variance of the coordinate values for each of the first point 210 through the fourth point 240, and the second line represents a right rear-side lane generated based on the mean (450 to 480) and/or variance of the coordinate values for each of the fifth point 250 through the eighth point 280 (e.g., forming two distinct polynomial curves representing adjacent lane boundaries).

Equation 3 is used by the lane generating unit 126 for generating a rear-side lane represented by a cubic polynomial (Y=a+bX+cX²+dX³) based on the average of the coordinate values of the respective points, in at least one example of the present disclosure. The cubic polynomial generated by the lane generating unit 126 represents a rear-side lane expressed as a lateral distance Y with respect to a longitudinal distance X (e.g., enabling compact parametric representation for downstream path planning or visualization).

$$[ \begin{matrix}1 & {X}_{1} & {X}_{1}^{2} & {X}_{1}^{3} \\ ⋮ & ⋮ & ⋮ & ⋮ \\ 1 & {X}_{n} & {X}_{n}^{2} & {X}_{n}^{3} \\ & & & \end{matrix} ] [ \begin{matrix}a \\ b \\ c \\ d\end{matrix} ] = [ \begin{matrix}{Y}_{1} \\ ⋮ \\ {Y}_{n}\end{matrix} ] ⇒ X [ \begin{matrix}a \\ b \\ c \\ d\end{matrix} ] = Y ⇒ {X}^{T} X [ \begin{matrix}a \\ b \\ c \\ d\end{matrix} ] = {X}^{T} Y ∴ [ \begin{matrix}a \\ b \\ c \\ d\end{matrix} ] = {( {X}^{T} X )}^{- 1} ( {X}^{T} Y ) \qquad [ Equation 3 ]$$

In Equation 3, Xᵢ and Yᵢ are the average coordinate values of i-th point, and [a, b, c, d] is a vector representing the coefficients of the cubic polynomial. Equation 3 shows the process of obtaining the cubic polynomial from the average coordinate values of the respective points by using an ordinary least squares fitting method (e.g., reducing or minimizing the sum of squared residuals between predicted and actual Y values, etc.), and one of ordinary skill in the art of the present disclosure will readily understand Equation 3, for polynomial regression, using ordinary least squares, so further explanation is omitted.

Equation 4 is used by the lane generating unit 126 for generating a rear-side lane represented by the cubic polynomial (Y=a+bX+cX²+dX³) based on the mean and variance of the coordinate values of the respective points, in another example of the present disclosure. The cubic polynomial generated by the lane generating unit 126 represents a rear-side lane expressed as a lateral distance Y with respect to a longitudinal distance X.

$$[ \begin{matrix}\frac{1}{{σ}_{1}} & 0 & 0 \\ 0 & ⋱ & 0 \\ 0 & 0 & \frac{1}{{σ}_{n}} \\ & & \end{matrix} ] [ \begin{matrix}1 & {X}_{1} & {X}_{1}^{2} & {X}_{1}^{3} \\ ⋮ & ⋮ & ⋮ & ⋮ \\ 1 & {X}_{n} & {X}_{n}^{2} & {X}_{n}^{3} \\ & & & \end{matrix} ] [ \begin{matrix}a \\ b \\ c \\ d\end{matrix} ] = [ \begin{matrix}\frac{1}{{σ}_{1}} & 0 & 0 \\ 0 & ⋱ & 0 \\ 0 & 0 & \frac{1}{{σ}_{n}} \\ & & \end{matrix} ] [ \begin{matrix}{Y}_{1} \\ ⋮ \\ {Y}_{n}\end{matrix} ] ⇒ σ X [ \begin{matrix}a \\ b \\ c \\ d\end{matrix} ] = σ Y ⇒ {( σ X )}^{T} σ X [ \begin{matrix}a \\ b \\ c \\ d\end{matrix} ] = {( σ X )}^{T} σ Y ∴ [ \begin{matrix}a \\ b \\ c \\ d\end{matrix} ] = {( {X}^{T} {σ}^{2} X )}^{- 1} ( {X}^{T} {σ}^{2} Y ) \qquad [ Equation 4 ]$$

In Equation 4, Xᵢ and Yᵢ are the average coordinate values of the i-th point, and [a, b, c, d] is a vector representing the coefficients of a cubic polynomial. σᵢ is the standard deviation of the coordinate values of the i-th point, and σ² is a diagonal matrix whose elements are the inverse of the variance for the respective points. Equation 4 shows the process of obtaining a cubic polynomial from the mean and variance for the respective points by using weighted least squares method (e.g., reducing the influence of points with higher variance, etc.), and one of ordinary skill in the art of the present disclosure will readily understand Equation 4 using weighted least squares, so further explanation is omitted.

By generating a cubic polynomial with the inverse of the variance of the coordinate values used as the weight, the lane generating unit 126 may generate a rear-side lane taking account of the position estimation error of the vehicle 10 and the lane detection error that occurs at each time point (e.g., sensor noise, motion-induced perturbations, or tracking inconsistency over time, etc.). With the lane generating unit 126 considering the variance of coordinate values when generating the rear-side lane, a more accurate rear-side lane may be generated (e.g., for safer trajectory planning, more precise target path prediction, or improved blind spot awareness, etc.).

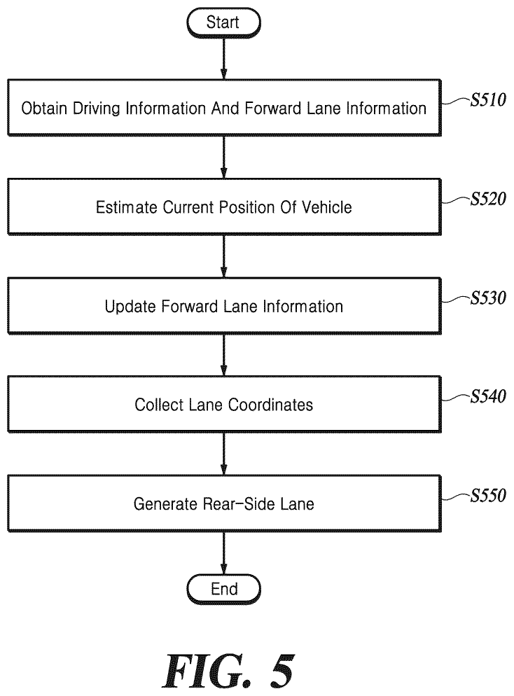

FIG. 5 shows an example of a method performed by the lane generating device 100 for generating a rear-side lane, according to at least one example of the present disclosure.

The lane generating device 100 obtains current driving information of the vehicle 10 by using at least one sensor included in the vehicle 10 and obtains forward lane information based on at least one forward sensor included in the vehicle 10 (S510) (e.g., camera, LiDAR, radar, or IMU, etc.).

The lane generating device 100 utilizes the current driving information of the vehicle 10 and/or the location information of the vehicle 10 at a previous point in time to calculate the current position information of the vehicle 10 (S520). The position information of the vehicle 10 includes a position (x, y) and/or a heading angle φ of the vehicle 10 (e.g., relative to a local vehicle coordinate frame or global navigation reference).

The lane generating device 100 updates the coordinate values of the previously collected forward lane coordinate(s) if stored in the memory 110 to conform to the vehicle coordinate system at the current time (S530) (e.g., by transforming the past coordinates to reflect updated ego-vehicle position and heading).

The lane generating device 100 uses the forward lane information to collect lane coordinate(s) for each of the multiple points on the forward lane ahead of the vehicle 10 (S540). The lane generating device 100 may collect coordinate values representing each of the points on the forward lane by storing the coordinate values in the memory 110, for example, for further statistical analysis or lane model fitting.

The lane generating device 100 generates a rear-side lane by using the forward lane coordinates stored in the memory 110 (S550). The lane generating device 100 may calculate a mean and/or variance of a plurality of the lane coordinates for the same point on the forward lane and generate the rear-side lane based on the mean and/or variance (e.g., to account for fluctuations across samples and build a robust estimate).

In another example of the present disclosure, the lane generating device 100 may determine whether to collect coordinates for each point at each time point (e.g., based on a dynamic confidence threshold, vehicle speed, or sensor quality indicators, etc.).

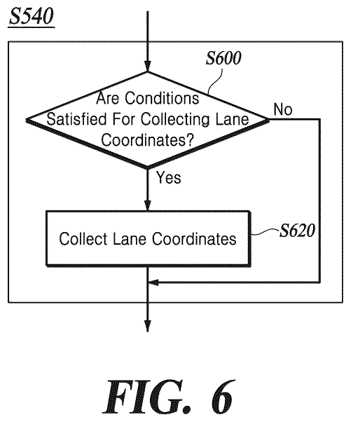

FIG. 6 shows an example of a process performed by the lane generating device 100 for determining whether to collect lane coordinates, according to another example of the present disclosure.

In Step S540 of the lane generating device 100 collecting lane coordinate(s) for each of the multiple points on the forward lane, the lane generating device 100 may determine whether to collect coordinates for each point (S600). To determine whether to collect coordinates for each point, the lane generating device 100 may utilize one or more of the following: the curvature of the forward lane, the lane detection reliability of the sensor used to obtain the forward lane information, the lane lateral offset of the vehicle 10 from the forward lane, the velocity of the vehicle 10, the steering angle of the vehicle 10, and the yaw rate of the vehicle 10 (e.g., to ensure only high-confidence data points are accumulated for modeling purposes).

The lane generating device 100 stores the lane coordinates in the memory 110 only if the conditions for collecting the lane coordinates are met (S620). The lane generating device 100 does not store the lane coordinates obtained at the current time if the conditions for collecting the lane coordinates are not met (e.g., to prevent erroneous or low-confidence data from degrading the lane model).

In one example, the lane generating device 100 determines whether the lane detection reliability of the sensor attached to the front of the vehicle 10 is less than or equal to a preset reference value (S600). The lane generating device 100 does not collect lane coordinates if the lane detection reliability is less than or equal to the preset reference value, and collects lane coordinates when the lane detection reliability is greater than the preset reference value (S620) (e.g., confidence level >80%).

In another example, the lane generating device 100 determines if the curvature of the forward lane is greater than or equal to a preset reference value (S600). The lane generating device 100 does not collect lane coordinates if the curvature is greater than or equal to the preset reference value, and collects lane coordinates if the curvature is less than the preset reference value (S620) (e.g., avoiding coordinate collection in tight turns where estimation uncertainty is high).

In yet another example, the lane generating device 100 determines whether the lane lateral offset of the forward lane is within the preset reference range (S600). The lane generating device 100 does not collect lane coordinates if the lane lateral offset is not within the preset reference range, and collects lane coordinates if the lateral offset is within the preset reference range (S620) (e.g., within +0.5 meters of lane center).

In yet another example, the lane generating device 100 determines whether the velocity of the vehicle 10 is within a preset reference range (S600). The lane generating device 100 does not collect lane coordinates if the velocity is not within the preset reference range, and collects lane coordinates if the velocity is within the preset reference range (S620) (e.g., between 30 km/h and 100 km/h, where sensor readings are typically stable).

In yet another example, the lane generating device 100 determines if the heading angle of the vehicle 10 is less than or equal to a preset reference value (S600). The lane generating device 100 does not collect lane coordinates if the heading angle is less than or equal to the preset reference value, and collects lane coordinates if the heading angle is greater than the preset reference value (S620) (e.g., to exclude data when the vehicle is driving in a nearly straight line without sufficient variation).

In yet another example, the lane generating device 100 determines whether the yaw rate of the vehicle 10 is less than or equal to a preset reference value (S600). The lane generating device 100 does not collect lane coordinates if the yaw rate is less than or equal to the preset reference value, and collects lane coordinates if the yaw rate is greater than the preset reference value (S620) (e.g., to ensure that sufficient rotational dynamics are present to justify data inclusion).

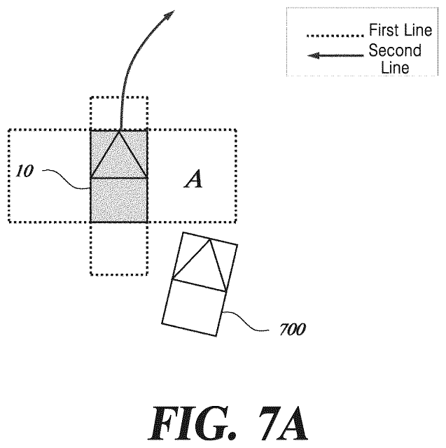

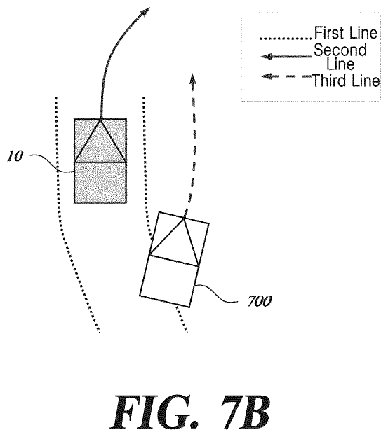

FIGS. 7A and 7B show an example of a lane generating device 100 according to the present disclosure improves the performance of a blind-spot collision warning/assist system (BCW/A).

Blind-spot collision warning/assist (BCW/A) is a function that warns of a collision risk with another vehicle (target) located rear laterally when the ego vehicle operates a turn signal to change lanes while driving or automatically controls the vehicle to help avoid the collision at a high-risk collision situation (e.g., by braking, steering intervention, or issuing visual/audio alerts, etc.).

FIG. 7A shows a trouble with a blind-spot collision warning/assist system when a target vehicle 700 approaches from the rear in a situation where the vehicle 10 without the lane generating device 100 is about to change lanes to the right. In FIG. 7A, the first line represents the boundary of a collision warning area A, and the second line represents a future path that the driver of the vehicle 10 without the lane generating device 100 intends to take without the benefit of rear-side lane prediction.

The blind-spot collision warning/assist system determines whether a target is in the collision warning area A and determines whether to issue a collision warning or control the vehicle only if the target is in the collision warning area A. In the situation of FIG. 7A, the target vehicle 700 is not in the collision warning area A, so the blind-spot collision warning/assist system does not perform a collision warning or initiate any vehicle control action (e.g., braking, steering intervention, or alert generation, etc.). Therefore, a collision between the vehicle 10 without the lane generating device 100 and the target vehicle 700 may occur due to a delayed or missed collision warning or vehicle control trigger.

FIG. 7B shows that the performance of a blind-spot collision warning/assist system may be improved by using a lane generation method (e.g., rear-side lane estimation based on past forward lane detections) according to the present disclosure in the same situation as FIG. 7A. In FIG. 7B, the first line represents a roadway on which the vehicle 10 is traveling, the second line represents a future path that the driver of the vehicle 10 intends to travel, and the third line represents a future path of the target vehicle 700 predicted based on the rear-side lane information generated by the lane generation method of the present disclosure (e.g., using cubic polynomial fitting based on accumulated coordinate points).

Since the vehicle 10 and the target vehicle 700 are traveling on a roadway with lanes marked, the target vehicle 700 is likely to be traveling along the lanes (e.g., following the centerline or staying within lane boundaries, etc.). Therefore, the blind-spot collision warning/assist system may receive the rear-side lane information generated by the lane generating device 100 to predict the future path of the target vehicle 700 in a form similar to the rear-side lane (e.g., parallel to the lane centerline). Referring to FIG. 7B, the future path of the target vehicle 700 is predicted in a form that is parallel to the lane, enabling detection of a collision risk earlier in a situation where the driver of the vehicle 10 is about to change lanes to the right. Thus, the performance of a blind-spot collision warning/assist system may be improved by using the lane generation method according to the present disclosure (e.g., providing earlier intervention or more accurate trajectory prediction).

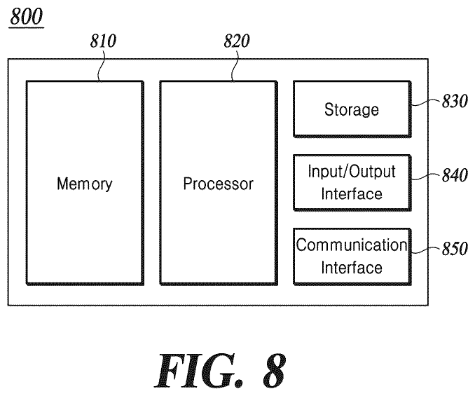

FIG. 8 shows an example of a configuration of a computing device 800 that may be used to implement the methods or devices according to the present disclosure.

The computing device 800 may include some or all of a memory 810, a processor 820, a storage 830, an input/output interface 840, and a communication interface 850. The computing device 800 may structurally and/or functionally include at least a portion of the lane generating device. The computing device 800 may be a stationary computing device, such as a desktop computer, server, or the like, as well as a mobile computing device, such as a laptop computer, smartphone, automotive-grade embedded controller, or the like.

The memory 810 may store programs that cause the processor 820 to perform methods or operations under various examples of the present disclosure. For example, the program may include a plurality of instructions executable by the processor 820 and the plurality of instructions may be executed by the processor 820 to perform the methods or operations described above. The memory 810 may be a single memory or a plurality of memories. In this case, the information required to perform the methods or operations according to various examples of the disclosure may be stored in a single memory or stored divisively among the plurality of memories. When the memory 810 is composed of a plurality of memories, they may be physically separated. The memory 810 may include at least one of volatile memory and non-volatile memory. The volatile memory may include static random access memory (SRAM) or dynamic random access memory (DRAM), for example, and the non-volatile memory may include flash memory, EEPROM, or MRAM, for example.

The processor 820 may include at least one core capable of executing at least one set of instructions. The processor 820 may execute instructions stored in the memory 810. The processor 820 may be a single processor or a plurality of processors (e.g., a multicore ARM processor or a custom automotive-grade SoC).

The storage 830 maintains stored data even when power to the computing device 800 is interrupted. For example, the storage 830 may include non-volatile memory or may include a storage medium such as magnetic tape, optical disk, or magnetic disk. Programs stored in the storage 830 may be loaded into the memory 810 before execution by the processor 820. The storage 830 may store files written in a program language, and programs generated by a compiler or the like may be loaded from the files into the memory 810. The storage 830 may store data to be processed by the processor 820 and/or data that has been processed by the processor 820.

The input/output interface 840 may provide an interface with an input device, such as a keyboard, mouse, touchscreen, etc. and/or with an output device, such as a display device, printer, indicator light, or Head-Up Display (HUD), etc. A user may trigger the execution of a program by the processor 820 via the input device and/or view the results of processing by the processor 820 via the output device.

The communication interface 850 may provide access to an external network. The computing device 800 may communicate with other devices via the communication interface 850 (e.g., through CAN, Ethernet, or V2X wireless protocols, etc.).

Each element of the apparatus or method in accordance with the present disclosure may be implemented in hardware or software, or a combination of hardware and software. The functions of the respective elements may be implemented in software, and a microprocessor may be implemented to execute the software functions corresponding to the respective elements (e.g., via embedded C, Python scripts, or real-time OS environments).

Various examples of systems and techniques described herein may be realized with digital electronic circuits, integrated circuits, field programmable gate arrays (FPGAs), application specific integrated circuits (ASICs), computer hardware, firmware, software, and/or combinations thereof. The various examples may include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data may be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium (e.g., an electrical, optical, or radio signal). Furthermore, the computer-readable recording medium may be distributed over computer systems connected through a network, and computer-readable program code may be stored and executed in a distributive manner.

According to at least one example, the present disclosure provides a method for generating a rear-side lane of a vehicle that is traveling in a lane, based on a front-side lane, the method comprising: obtaining coordinate values of each of a plurality of points on the front-side lane, at predetermined time intervals, by using at least one sensor attached to the vehicle, wherein the coordinate values are defined in a cartesian coordinate system with the vehicle at a origin, a first axis parallel to a direction of the vehicle, and a second axis perpendicular to the direction of the vehicle; and generating a lane curve representing the rear-side lane based on coordinate values of a plurality of rear-side points, wherein the plurality of rear-side points are points from the plurality of points that are positioned to the rear side of the vehicle as the vehicle moves forward.

According to another example, the present disclosure provides an apparatus for generating a rear-side lane of a vehicle that is traveling in a lane, based on a front-side lane, comprising: at least one memory configured to store instructions; and at least one processor, wherein the at least one processor executes the instructions for causing the processor to perform the steps of: obtaining coordinate values of each of a plurality of points on the front-side lane, at predetermined time intervals, by using at least one sensor attached to the vehicle, wherein the coordinate values are defined in a cartesian coordinate system with the vehicle at a origin, a first axis parallel to a direction of the vehicle, and a second axis perpendicular to the direction of the vehicle; and generating a lane curve representing the rear-side lane based on coordinate values of a plurality of rear-side points, wherein the plurality of rear-side points are points from the plurality of points that are positioned to the rear side of the vehicle as the vehicle moves forward.

According to at least one example, by utilizing the forward lane information and the vehicle position information, the present disclosure may generate the rear-side lane even when the rear-side lane information may not be directly detected.

According to at least one example, by using a statistical method, the present disclosure may minimize lane information errors caused by vehicle jolting or sensor measurement errors, thereby improving the accuracy of rear-side lane generation.

Although operations are shown in the flowcharts/timing charts in this specification as being sequentially performed, this is merely an exemplary description of the technical idea of one example of the present disclosure. In other words, those skilled in the art to which one example of the present disclosure belongs may appreciate that various modifications and changes may be made without departing from essential features of an example of the present disclosure, that is, the sequence shown in the flowcharts/timing charts may be changed and one or more operations of the operations may be performed in parallel. Thus, flowcharts/timing charts are not limited to the temporal order.

Although examples of the present disclosure have been described for illustrative purposes, those skilled in the art will appreciate that various modifications, additions, and substitutions are possible, without departing from the idea and scope of the claimed disclosure. Therefore, examples of the present disclosure have been described for the sake of brevity and clarity. The scope of the technical idea of the present examples is not limited by the illustrations. Accordingly, one of ordinary skill would understand that the scope of the claimed disclosure is not to be limited by the above explicitly described examples but by the claims and equivalents thereof.

What is claimed:

1. A method performed by an apparatus of a vehicle, the method comprising:
obtaining coordinate values of a plurality of points on a lane ahead of the vehicle at predetermined time intervals using at least one sensor of the vehicle,
wherein the coordinate values are defined in a cartesian coordinate system having the vehicle at an origin, a first axis parallel to a direction of travel of the vehicle, and a second axis perpendicular to the direction of travel;
generating a signal indicating a lane curve representing a rearward portion of the lane based on coordinate values of a plurality of rear-side points,
wherein the plurality of rear-side points correspond to points from the plurality of points that are positioned to a rear side of the vehicle as the vehicle moves forward; and
controlling, based on the signal, driving of the vehicle.

2. The method of claim 1, wherein the lane curve is represented by a polynomial, and wherein the lane curve is determined based on a difference between point values of the polynomial and the coordinate values of the plurality of rear-side points being minimized.

3. The method of claim 2, wherein the lane curve is a cubic polynomial.

4. The method of claim 1, wherein the generating of the signal comprises:
determining an average of candidate coordinate values of each rear-side point of the plurality of rear-side points; and
generating the lane curve based on the averages of the candidate coordinate values of the plurality of rear-side points.

5. The method of claim 1, wherein the generating of the signal comprises:
determining an average of candidate coordinate values of each rear-side point of the plurality of rear-side points and a variance of the candidate coordinate values of each rear-side point of the plurality of rear-side points; and
generating a lane curve based on a difference between point values associated with the lane curve and the averages of the candidate coordinate values of the plurality of rear-side points being minimized, and wherein the lane curve is further based on weights proportional to an inverse of each of the variances.

6. The method of claim 1, wherein the obtaining of the coordinate values of the plurality of points on the lane ahead of the vehicle comprises:
excluding, based on a lane detection reliability of the at least one sensor, invalid coordinate values from the coordinate values of the plurality of points.

7. The method of claim 1, wherein the obtaining of the coordinate values of the plurality of points on the lane ahead of the vehicle comprises:
excluding, based on a curvature of the lane ahead of the vehicle, invalid coordinate values from the coordinate values of the plurality of points.

8. The method of claim 1, wherein the obtaining of the coordinate values of the plurality of points on the lane ahead of the vehicle comprises:
excluding, based on a lateral offset of the lane ahead of the vehicle, invalid coordinate values from the coordinate values of the plurality of points.

9. The method of claim 1, wherein the obtaining of the coordinate values of the plurality of points on the lane ahead of the vehicle comprises:
excluding, based on a velocity of the vehicle, invalid coordinate values from the coordinate values of the plurality of points.

10. The method of claim 1, wherein the obtaining of the coordinate values of the plurality of points on the lane ahead of the vehicle comprises:
excluding, based on a heading angle of the vehicle, invalid coordinate values from the coordinate values of the plurality of points.

11. The method of claim 1, wherein the obtaining of the coordinate values of the plurality of points on the lane ahead of the vehicle comprises:
excluding, based on a yaw rate of the vehicle, invalid coordinate values from the coordinate values of the plurality of points.

12. An apparatus of a vehicle, the apparatus comprising:
a processor; and
a memory storing at least one instruction that, when executed by the processor communicating with the memory, is configured to cause the apparatus to:
obtain coordinate values of a plurality of points on the lane ahead of the vehicle at predetermined time intervals using at least one sensor of the vehicle, wherein the coordinate values are defined in a cartesian coordinate system having the vehicle at an origin, a first axis parallel to a direction of travel of the vehicle, and a second axis perpendicular to the direction of travel;
generate a signal indicating a lane curve representing a rearward portion of the lane based on coordinate values of a plurality of rear-side points, wherein the plurality of rear-side points correspond to points from the plurality of points that are positioned to a rear side of the vehicle as the vehicle moves forward; and
control, based on the signal, driving of the vehicle.

13. A method performed by an apparatus of a vehicle, the method comprising:
obtaining forward lane detection information from at least one sensor of the vehicle at predetermined intervals, wherein the forward lane detection information comprises coordinate values for a plurality of points on a lane ahead of the vehicle;
estimating, based on driving information obtained from the vehicle, a current position of the vehicle at each of the predetermined intervals;
updating, based on the estimated current position of the vehicle at each of the predetermined intervals, coordinate values of previously obtained points on the lane such that the updated coordinate values correspond to points positioned rearward of the vehicle as the vehicle moves forward;
outputting, based on the updated coordinate values of the points positioned rearward of the vehicle, a signal indicating a rearward portion of the lane; and
controlling, based on the signal indicating the rearward portion of the lane, driving of the vehicle.

14. The method of claim 13, wherein the estimating of the current position of the vehicle at each of the predetermined intervals comprises:
determining a current vehicle position using dead reckoning based on the driving information, wherein the driving information comprises at least one of a velocity of the vehicle, an acceleration of the vehicle, a steering angle of the vehicle, a steering angle velocity of the vehicle, a heading angle of the vehicle, or a yaw rate of the vehicle.

15. The method of claim 13, wherein the updating of the coordinate values comprises:
updating the coordinate values of previously obtained points on the lane from earlier time points into a coordinate system defined at the estimated current position of the vehicle and heading of the vehicle.

16. The method of claim 13, wherein the outputting of the signal comprises:
determining, based on the updated coordinate values corresponding to the points positioned rearward of the vehicle, a polynomial lane curve using a least squares fitting method.

17. The method of claim 13, wherein the outputting of the signal comprises:
based on an average of the updated coordinate values corresponding to the points positioned rearward of the vehicle and a variance of the updated coordinate values corresponding to the points positioned rearward of the vehicle, determining a polynomial lane curve using a weighted least squares fitting method, wherein the polynomial lane curve is determined such that differences between the polynomial lane curve and the updated coordinate values are weighted based on an inverse of the variance.

18. The method of claim 13, wherein the at least one sensor comprises a forward-facing camera, and wherein the forward lane detection information comprises at least one of a lane lateral offset between the lane and the vehicle, a lane heading angle, a lane curvature of the lane ahead of the vehicle, or a lane curvature rate of the lane curvature.

19. The method of claim 13, wherein the controlling of the driving of the vehicle comprises:
providing the signal to a blind-spot collision warning or assist (BCW/A) system of the vehicle, wherein the BCW/A system is configured to predict, based on the signal indicating the rearward portion of the lane, a future path of a target vehicle positioned rearwardly of the vehicle.

20. The method of claim 13, further comprising selectively storing the coordinate values based on at least one of:
a reliability of a sensor exceeding a reference value,
a curvature of the lane ahead of the vehicle being below a reference value,
a lateral offset between the vehicle and the lane ahead of the vehicle being within a reference range,
a velocity of the vehicle being within a reference range,
a steering angle of the vehicle exceeding a reference value, or
a yaw rate of the vehicle exceeding a reference value.
